(19) United States
(12) Patent Application Publication
(10) Pub. No.: US 2016/0245636 A1
(43) Pub. Date: Aug. 25, 2016

(54) TELESCOPIC WINDOW MEASUREMENT APPARATUS

(71) Applicants: Paul W. Blackner, Johnstown, PA (US); Judith M. Blackner, Johnstown, PA (US)

(72) Inventors: Paul W. Blackner, Johnstown, PA (US); Judith M. Blackner, Johnstown, PA (US)

(21) Appl. No.: 14/626,651

(22) Filed: Feb. 19, 2015

(51) Int. Cl. G01B 5/14; G01B 5/02; E04F 21/00

(52) U.S. Cl. CPC G01B 5/14; E04F 21/003; G01B 5/02

(57) ABSTRACT

A window measurement apparatus for measuring bay windows spaces. The window measurement apparatus comprises an extendable rod member and various attachable end plates. The extendable rod member has a first rod section slidably nested in a second rod section, which itself is slidably nested in a third rod section, thereby enabling the extendable rod member to telescopically extend and retract longitudinally between a fully extended position and a fully retracted position. Each end of the extendable rod member includes an end plug that has a fastener hole for receiving a conventional elongated fastener, thereby enabling any one of the attachable end plates can be attached to the ends of the extendable rod member.

### BACKGROUND OF THE INVENTION

1. Field of the Invention

This invention relates generally to tool accessories and, more particularly, to a telescopic rod with attachable end pieces for measuring window space for window treatments.

2. Description of the Prior Art

The structure and design of bay windows in buildings is well known. Due to the protruding nature of such windows, however, a problem which still exists is that it is often difficult to obtain accurate measurements of each angled or curved surface in order to establish the appropriate size for blinds or shades. Thus, there remains a need for a window measurement apparatus that can be selectively extended and retracted to enable to both measure wider spans and more narrow areas. It would be helpful if such a window measurement apparatus included a plurality of selectively attachable end plates for use in measurements. It would be additionally desirable for each of such attachable end plates to correspond in size and shape to a specific sized headrails to increase the precision of the measurement.

The Applicant's invention described herein provides for a window measurement apparatus adapted to allow a user to selectively extend its length to measure a bay window space. The primary components in Applicant's a window measurement apparatus are a plurality of telescoping rods and attachable end plates. When in operation, the window measurement apparatus enables a more efficient and precise method of measuring spaces for blinds and window treatments in a bay window, thereby eliminating the guesswork typically involved in the same. As a result, many of the limitations imposed by prior art structures are removed.

### SUMMARY OF THE INVENTION

A window measurement apparatus for measuring bay windows spaces. The window measurement apparatus comprises an extendable rod member and various attachable end plates. The extendable rod member has a first rod section slidably nested in a second rod section, which itself is slidably nested in a third rod section, thereby enabling the extendable rod member to telescopically extend and retract longitudinally between a fully extended position and a fully retracted position. Each end of the extendable rod member includes an end plug that has a fastener hole for receiving a conventional elongated fastener, thereby enabling any one of the attachable end plates can be attached to the ends of the extendable rod member.

In accordance with the same, the extendable rod member provides a rod means for measuring in bay window spaces and the attachable end plates each define an end means integral with the extendable rod member for accounting for headrail size.

It is an object of this invention to provide a window measurement apparatus that can be selectively extended and retracted to enable to both measure wider spans and more narrow areas.

It is another object of this invention to provide a window measurement apparatus that includes a plurality of selectively attachable end plates for use in measurements.

It is yet another object of this invention to provide a window measurement apparatus that includes attachable end plates that correspond in size and shape to specific sized headrails to increase the precision of the measurements for various styles of blinds and window treatments.

These and other objects will be apparent to one of skill in the art.

### BRIEF DESCRIPTION OF THE DRAWINGS

FIG. 1A is a side perspective view of the extendable rod member of a window measurement apparatus built in accordance with the present invention in its fully extended position.

FIG. 1B is a side perspective view of the extendable rod member of a window measurement apparatus built in accordance with the present invention in its fully retracted position.

FIG. 2 is a side elevational view of the various attachable end pieces of a window measurement apparatus built in accordance with the present invention.

FIG. 3 is a side elevational view of the various attachable end pieces of a window measurement apparatus built in accordance with the present invention.

### DETAILED DESCRIPTION OF THE INVENTION

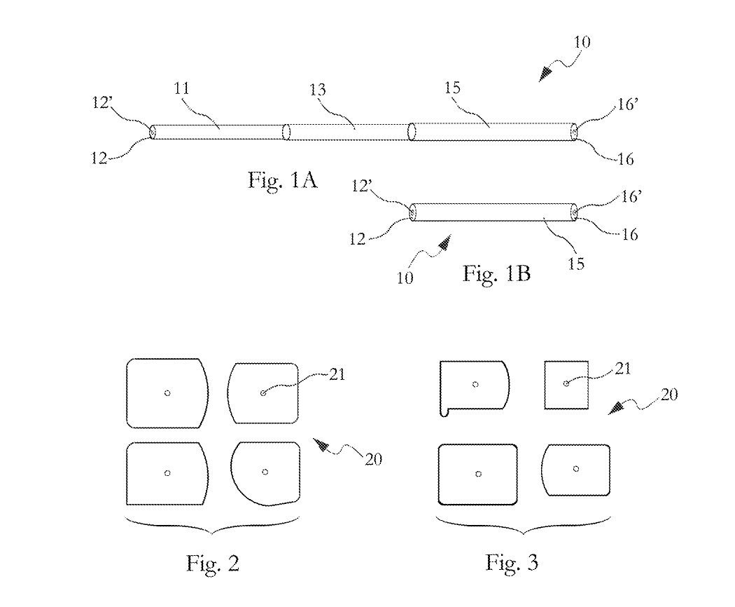

Referring now to the drawings and in particular FIGS. 1A and 1B, an extendable rod member 10 of a window measurement apparatus is shown having a first rod section 11, a second rod section 13, and a third rod section 15. In one embodiment, the first rod section, 11, second rod section 13, and third rod section 15 each define a rigid, hollow tube measuring 18 inches. In one embodiment, the first rod section 11, second rod section 13, and third rod section 15 are constructed of PVC. In another embodiment, the first rod section, 11, second rod section 13, and third rod section 15 are constructed of aluminum.

The first rod section 11 is sized to nest in the second rod section 13, and the second rod section is sized to nest in third rod section 15. The assembled extendable rod member 10 defines the first rod section 11 slidably nested in the second rod section 13 and the second rod section slidably nested in the third rod section 15, thereby enabling the extendable rod member 10 to telescopically extend and retract longitudinally between a fully extended position, as illustrated by FIG. 1A, and a fully retracted position, as illustrated by FIG. 1B.

The distal end of the first rod section 11 relative to the second rod section 13 includes a small end plug 12 that measures ¾ of an inch in one embodiment and includes a first fastener hole 12′ for receiving a conventional elongated fastener (not shown). Similarly, the distal end of the third rod section 15 relative to the second rod section includes a large end plug 16 that measures 1¼ inches in one embodiment and includes a second fastener hole 16′ for receiving a conventional elongated fastener (not shown). Through these fastener holes 12′, 16′, various attachable end plates can be attached to both ends of the extendable rod member 10.

Referring now to FIGS. 2 and 3, exemplary designs of attachable end plates 20 are illustrated. Each attachable end plate 20 includes a mounting aperture 21 in its body to enable it to receive a conventional elongated fastener so that it can be attached to the ends of the extendable rod member. It is contemplated that such attachable end plates 20 are sized and shaped to correspond to different styles of headrails and other mounting structures for various styles of blinds and window treatments.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A window measurement apparatus, comprising:
a rod member having a first end and an opposing second end, wherein the extendable rod member includes at least a discrete first rod section slidably nested in a discrete second rod section, thereby enabling the rod member to telescopically extend and retract longitudinally; and
at least one attachable end plate, wherein the first end and the second end are configured to receive the at least one attachable end plate and the at least one attachable end plate is adapted to be attached to the first end and second end.

2. The window measurement apparatus of claim 1, wherein said rod member including a small end plug integral with said first end and a large end plug integral with said second end, thereby configuring the first end and the second end to receive the at least one attachable end plate.

3. The window measurement apparatus of claim 2, wherein the small end plug and the large end plug each include a fastener hole therein.

4. The window measurement apparatus of claim 1, wherein each of the at least one attachable end plate includes a mounting aperture therein.

5. A window measurement apparatus, comprising:
a rod means for measuring bay window spaces; and
at least one end means integral with the rod means for accounting for headrail size.
